(19) United States
(12) Patent Application Publication
(10) Pub. No.: US 2007/0252312 A1
(43) Pub. Date: Nov. 1, 2007

(54) Parison control

(75) Inventor: Michael J. Lonsway, Toledo, OH (US)

Correspondence Address: MILES & STOCKBRIDGE PC, 1751 PINNACLE DRIVE, SUITE 500, MCLEAN, VA, 22102-3833, US

(73) Assignee: Graham Packaging, LP, York, PA (US)

(21) Appl. No.: 11/414,213

(22) Filed: May 1, 2006

(51) Int. Cl. B29C 49/00

(52) U.S. Cl. 264/523; 425/528; 264/540

(57) ABSTRACT

A parison control apparatus may include a gripper, to grasp and release an end of an extruded parison while the parison is being extruded; and an extendable support, coupled to the gripper, to raise the gripper to grasp the parison and to lower the gripper, pulling the parison downward and keeping the parison substantially straight.

### BACKGROUND OF THE INVENTION

1. Field of the Invention

The present invention relates generally to controlling extrusion of a parison on a free-hanging parison blow molder.

2. Related Art

In some blow-molding devices, a parison is extruded downward from a die-head so that the parison is free-hanging. A mold is moved into position to close around the free-hanging parison, and the container is blow-molded.

For larger containers, however, the portion of the parison extruded must be longer than for smaller containers, especially for tandem container, where the containers are blown in pairs, neck-to-neck or base-to-base, and for handle-ware packages. Longer parisons have a tendency to curl. When the mold closes around a curled parison, the resulting container is likely to be misshapen.

What is needed is a way to extrude longer parisons that overcomes shortcomings of conventional solutions.

### BRIEF SUMMARY OF THE INVENTION

In summary, the present invention, in an exemplary embodiment, provides an apparatus, comprising: a gripper, adapted to grasp and release an end of an extruded parison while the parison is being extruded; and an extendable support, coupled to the gripper, adapted to raise the gripper to grasp the parison and to lower the gripper, whereby the parison is pulled downward and kept substantially straight.

In another exemplary embodiment, the present invention provides a method comprising: extending an extendable support; grasping a parison with a gripper coupled to the extendable support, while the parison is being extruded, and release an end of an extruded parison; and lowering the extendable support, whereby the parison is pulled downward and kept substantially straight by the gripper.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an exemplary embodiment of a parison control apparatus according to the present invention;

FIG. 2 depicts an exemplary embodiment of the parison control apparatus with a mold closed around a parison according to the present invention;

FIG. 3 depicts a front view of an exemplary parison control apparatus in an elevated position according to the present invention; and

FIG. 4 depicts a front view of an exemplary parison control apparatus in a retracted position according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

In an exemplary embodiment, an apparatus according to the present invention includes a parison gripper that extends to grip the bottom of an extruding parison and pulls the parison gently downward until the mold closes over the parison. The parison gripper may become the base of the mold, or may remain separate from the mold.

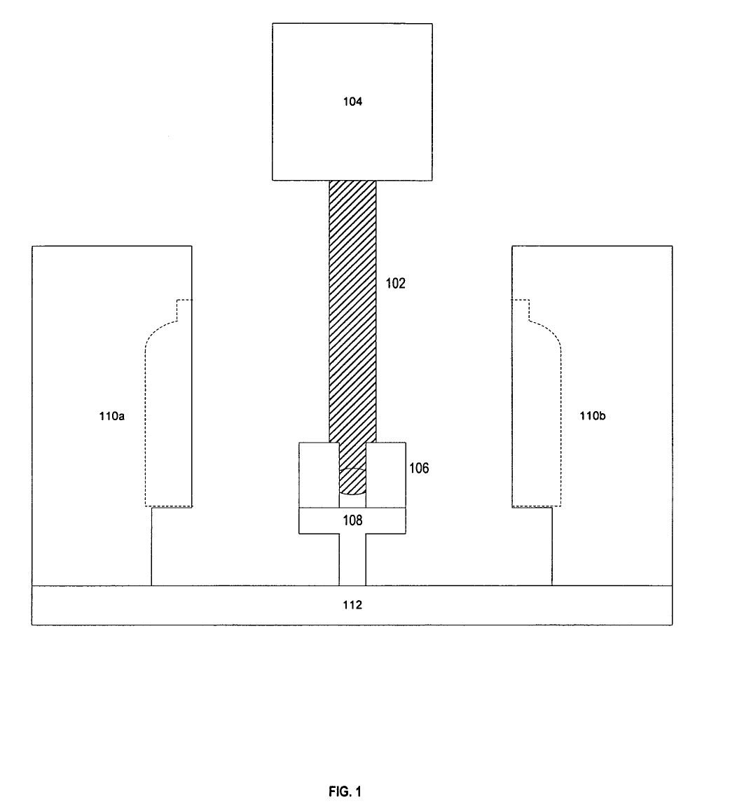

FIG. 1 depicts a side view of an embodiment of the present invention. Parison 102 is being extruded downward from die-head 104. Gripper 106, mounted on an extendable support 108, has grasped the bottom of parison 102 and pulled the parison downwards. Mold halves 110a, 110b may then close around parison 102 once the gripper 106 and support 108 have pulled the parison 102 sufficiently downward.

Many configurations for gripper 106 are possible. Functionally, gripper 106 may grasp and release a parison, and may be coupled to the extendible support 108.

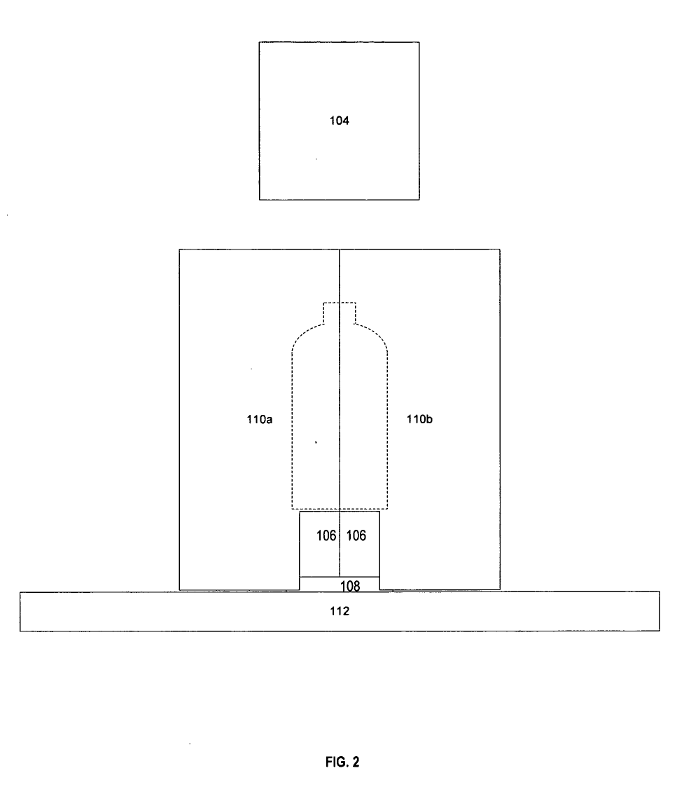

In one exemplary embodiment (not shown), gripper 106 may be separate and independent of the molds used. In such an embodiment, gripper 106 may effectively pull parison 102 downward for a period of time before a mold is moved into position around the parison. In the embodiment shown in FIGS. 1 and 2, gripper 106 is part of the mold and may be supported by gripper platform 112. In this embodiment, gripper 106 begins to pull parison 102 as the mold is closing around the parison, which may result in a shorter pulling period as compared to the embodiment where gripper 106 is independent of the mold.

FIG. 2 depicts a side view of an embodiment of the invention (not to scale) where the mold halves 110 have closed around the parison 102. In some embodiments, the gripper 106 forms part of the base of the mold 110. The gripper 106 may also sever the portion of the parison 102 held in the gripper 106 from the mold 110, eliminating some flash or scrap material from the molded container.

Gripper 106 may alternatively not form a part of the mold 110. In this embodiment, once the mold closes around a parison 102, the mold 110 and parison 102 may be removed to another area in the manufacturing process while a new parison is stretched by the gripper

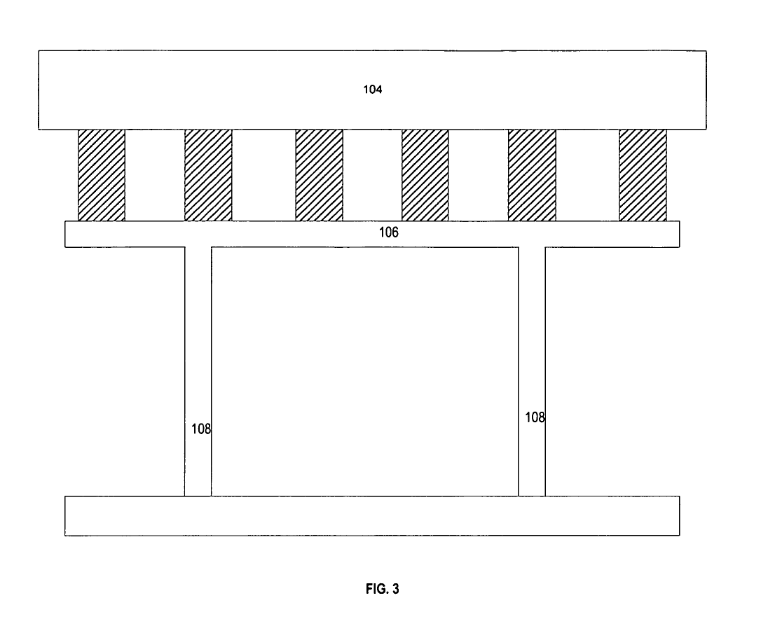

FIG. 3 depicts a front view of an embodiment of the invention where the gripper 106 may grasp multiple parisons at the same time. Gripper 106 is depicted in an initial grasping position, prior to pulling the parisons downward.

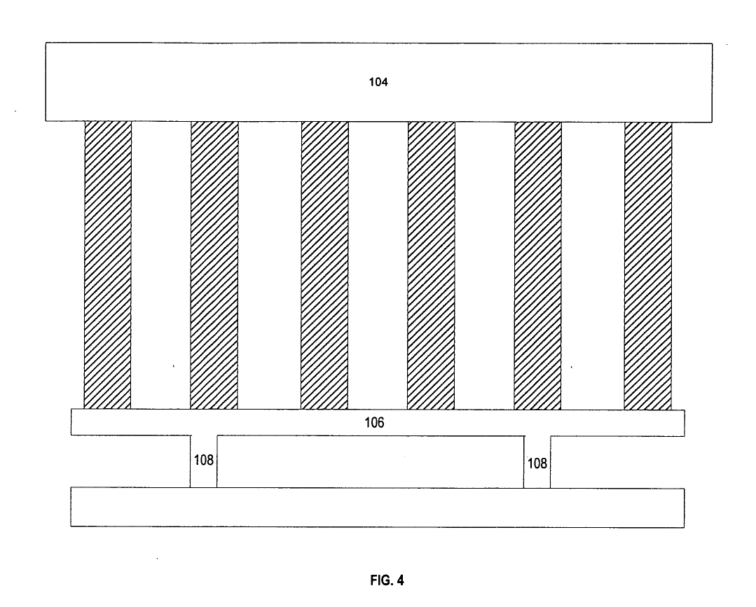

FIG. 4 depicts the embodiment shown in FIG. 3 where the parisons have been pulled down as the extendible supports 108 lower the gripper 106.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. An apparatus, comprising:
a gripper, adapted to grasp and release an end of an extruded parison while the parison is being extruded; and
an extendable support, coupled to the gripper, adapted to raise the gripper to grasp the parison and to lower the gripper, whereby the parison is pulled downward and kept substantially straight.

2. The apparatus of claim 1, further comprising a mold including two mold halves adapted to close around the parison and above the gripper.

3. The apparatus of claim 2, wherein the gripper forms the base of the mold when the mold halves close around the parison.

4. The apparatus of claim 3, further comprising a gripper platform coupled to said mold.

5. The apparatus of claim 2, wherein the gripper severs the bottom of the parison from the mold.

6. The apparatus of claim 1, wherein the gripper grasps a plurality of parisons.

7. The apparatus of claim 6, wherein the gripper grasps the plurality of parisons simultaneously.

8. The apparatus of claim 2, wherein the gripper grasps a plurality of parisons.

9. The apparatus of claim 8, wherein the gripper grasps the plurality of parisons simultaneously.

10. The apparatus of claim 2 further comprising a blowing apparatus for blowing a gas into the parison to form a plastic product.

11. The apparatus of claim 10, wherein the gripper grasps a plurality of parisons.

12. The apparatus of claim 11, wherein the gripper grasps the plurality of parisons simultaneously.

13. A method, comprising:
extending an extendable support;
grasping a parison with a gripper coupled to the extendable support, while the parison is being extruded, and release an end of an extruded parison; and
lowering the extendable support, whereby the parison is pulled downward and kept substantially straight by the gripper.

14. The method of claim 13, further comprising:
closing a mold including two mold halves around the parison and above the gripper.

15. The method of claim 14, further comprising forming the base of the mold with the gripper when the mold halves close around the parison.

16. The method of claim 13, further comprising severing the bottom of the parison from the mold with the gripper.

17. The method of claim 13, further comprising grasping a plurality of parisons.

18. The method of claim 17, further comprising grasping the plurality of parisons simultaneously.

19. The method of claim 14, further comprising grasping a plurality of parisons.

20. The method of claim 19, further comprising grasping the plurality of parisons simultaneously.

21. The method of claim 14 further comprising blowing a gas into the parison to form a plastic product.

22. The method of claim 21, further comprising grasping a plurality of parisons.

23. The method of claim 22, further comprising grasping the plurality of parisons simultaneously.
